(19) United States
(12) Patent Application Publication
(10) Pub. No.: US 2021/0206370 A1
(43) Pub. Date: Jul. 8, 2021

(54) Driving Through and Leaving a Roundabout in an Automatic Longitudinal Guidance Operation

(71) Applicant: Bayerische Motoren Werke Aktiengesellschaft, Muenchen (DE)

(72) Inventors: Andreas LECHNER, München (DE); Miguel LOENNE, München (DE); Sebastien MATHIEU, Fürstenfeldbruck (DE)

(73) Assignee: Bayerische Motoren Werke Aktiengesellschaft, München (DE)

(21) Appl. No.: 17/055,961

(22) PCT Filed: May 14, 2019
(86) PCT No.: PCT/EP2019/062277

§ 371 Date: Nov. 16, 2020

(30) Foreign Application Priority Data
May 17, 2018 (DE) 10 2018 207 804.1

(51) Int. Cl. B60W 30/14; B60W 30/18; B60W 40/105; G06K 9/00

(52) U.S. Cl. CPC B60W 30/143; B60W 30/18145; B60W 30/18154; B60W 2520/105; G06K 9/00825; B60W 2552/05; B60W 40/105

(57) ABSTRACT

A method for dynamically driving through and leaving a roundabout in an automatic longitudinal guidance operation includes detecting an exit of the roundabout which a vehicle will drive through, providing an acceleration point which is located before the exit, and accelerating the vehicle to an exit speed of the vehicle when the acceleration point is reached by the vehicle.

### BACKGROUND AND SUMMARY OF THE INVENTION

The invention relates to a method for adjusting the speed of a vehicle in accordance with automated detection of a vehicle leaving a roundabout. According to the invention it is possible to bring about human-like driving behavior when a vehicle leaving a roundabout is detected and nevertheless to adjust the speed of the vehicle dynamically. In addition, the present invention relates to a correspondingly configured system arrangement. Furthermore, a computer program product is proposed having control instructions which implement the method or operate the proposed system arrangement.

DE 10 2015 213 182 B3 presents a longitudinally guiding driver assistance system in a motor vehicle having a first sensing system for detecting currently valid events or upcoming relevant events which require a change in the maximum permissible speed, a second sensing system for detecting the route profile, a function unit which, when a relevant event is detected, takes into account the location of the relevant event in determining a location-dependent point in time at which the function unit will bring about automatic adaptation of the current maximum permissible speed.

DE 10 2012 213 933 A1 presents a method for controlling a cruise control system of a motor vehicle which basically adjusts the speed to a predefined setpoint speed, wherein at least during cornering of the motor vehicle the cruise control system adjusts the speed to a predefined reduced setpoint angular velocity as part of a cornering mode.

DE 10 2014 215 259 A1 presents a method for automatically selecting a driving mode at a motor vehicle while it is traveling along a roadway, comprising the steps of acquiring driving situation information which describes a driving situation, selecting a driving mode from a plurality of possible driving modes, and setting the driving mode on the motor vehicle.

A longitudinal control system which permits automatic intervention into the target speed (cruise controller) is known. Furthermore, a conventional cruise controller has a position control system which converts a speed and an acceleration at a location relative to the actual position as a target specification. In addition, the prior art presents a navigation system which can transmit upcoming map attributes in the form of segments and their properties to the longitudinal control system. Furthermore, in this context a system is required which can adjust the speed to events (bends, roundabout, turn off, sets of traffic lights, . . . ) from the digital map in an automated fashion. In addition, a prediction of which will be the most probable path that the vehicle will travel along is known.

The prior art has the disadvantage that excessively slow dynamics are present at the exit from the roundabout if an assumed target speed is maintained until the roundabout has been completely exited. Therefore, not only is the driving experience degraded, vehicles traveling behind must also unnecessarily slow down and there is the risk of tail-end collisions. In addition, when a vehicle leaves the roundabout conventional cruise controllers provide alienating behavior which is not like that of a human.

An object of the present invention is to propose an improved, in particular more dynamic and safer, method for driving through and leaving a roundabout in an automatic longitudinal guidance operation. In addition, an object of the present invention is to provide a correspondingly configured system arrangement and to propose a computer program product with control instructions which implement the method and/or at least partially operate the proposed system arrangement.

Accordingly, a method for dynamically driving through and leaving a roundabout in an automatic longitudinal guidance operation is proposed, comprising detecting an exit of the roundabout which the vehicle will drive through, wherein an acceleration point which is located before the exit is provided; and acceleration to an exit speed of the vehicle is implemented when the acceleration point is reached.

According to the invention, the disadvantage is overcome that before a vehicle leaves the roundabout a conventional cornering system does not already accelerate out of the roundabout but instead maintains the reduced speed. Consequently, in the prior art there is the problem that vehicles which are traveling behind and which are driving, for example, more quickly than the vehicle traveling ahead are impeded. This results in the problem that tail-end collisions are caused within a roundabout. Furthermore, it corresponds to a dynamic driving style that drivers already like to accelerate as they leave the roundabout, that is to say when they are still within the roundabout, and then leave the roundabout onto the target road at an increased speed.

Such a driving behavior is generally not only safer but can also be found to occur in a manual driving mode, and therefore actually corresponds to human behavior. Since drivers of vehicles traveling behind cannot detect whether a vehicle traveling in front is being guided in the manual driving mode or is being guided according to an automatic longitudinal guidance system, it is to a certain extent surprising for drivers traveling behind if a flashing indicator light for leaving the roundabout is set but the vehicle carries on driving at a reduced cornering speed. This is eliminated according to the invention.

In order to detect when the vehicle leaves the roundabout, automated checking of the route profile is necessary. For this purpose it is proposed that either route guidance is read out of the navigation device or else the setting of a flashing indicator light is evaluated. In this context, it is particularly advantageous that both methods can be combined with one another and in addition only conventional components, which are operated according to the invention, are used.

Furthermore, it is detected according to the invention whether a roundabout has a plurality of lanes, and the flashing indication behavior of the driver is analyzed. If, for example, right-hand traffic is present, the driver is indicating that he wishes to leave the roundabout. However, if the driver issues a flashing indication on the left, the driver indicates that he wishes to change lane. According to one aspect of the present invention, the proposed method only reacts to flashing indications in the direction of exits. In the case of right-hand traffic, the proposed method therefore ignores a left-hand flashing indication.

Furthermore, according to the invention it can be detected whether right-hand traffic or left-hand traffic is present. Therefore, in normal road traffic the vehicle typically drives for a relatively long distance on the correct roadway. An optical system, for example a front looking camera, can be used to detect which lane the vehicle is normally located on. Of course, if predominantly right-hand traffic is present the vehicle would travel for a relatively long time on a right-hand roadway, wherein a relatively short period of time on the left-hand roadway can be ignored. Therefore, according to the invention overtaking, which takes place on the respective opposite lane, is disregarded.

In a further alternative, the navigation system is read out and in the process the country in which the vehicle is moving becomes apparent. For this purpose, a table is kept available which indicates for each country whether left-hand traffic or right-hand traffic is legally required.

If the exit of the roundabout which is to be driven through has actually been detected, a virtual point is set at which the conventional cornering longitudinal guidance is aborted and acceleration out of the roundabout occurs. In this context, a point in time or else also a distance can be entered. The speed can therefore be read out from the vehicle computer and it can be specified that acceleration occurs, for example, three seconds before the vehicle leaves the roundabout. In addition, on the basis of this information it is also possible to specify that acceleration occurs 10 meters before the vehicle leaves the roundabout. The driver can provide these values or the manufacturer can determine them empirically and store them in a vehicle memory.

It is also possible to implement different driving modes and at the same time indicate whether a sporty mode or a comfortable mode is implemented. In a sporty mode, acceleration occurs after the bend at an extreme early time and the vehicle therefore already drives into the exit at a relatively high speed. In the case of a comfortable mode, the conventional cornering guidance is executed for longer and later acceleration occurs. By means of this strategy it is also possible to define how high the acceleration will be. The acceleration can also be adjusted dynamically and set in accordance with the current speed and a bend radius. Known methods also do not take into account that a more different driving experience is desired, for example, in a sporty mode than in a comfort mode. In the case of a sporty driving style, a higher lateral acceleration is tolerated than in the case of a comfortable mode. This is not sufficiently taken into account by conventional methods.

If acceleration is implemented, a conventional cruise controller can also be used. A typical driving profile is one in which a driver approaches a roundabout with his vehicle in the cruise control mode. Then, in an automatic longitudinal guidance operation the vehicle is braked for the roundabout and guided through the roundabout at a reduced speed. Since the method according to the invention now brings about acceleration out of the roundabout, it is possible to switch back into the conventional cruise control. In this way, the proposed method therefore has the effect that conventional bend guidance operations which typically brake the motor vehicle are switched off early.

The cruise control is then switched on, and it changes again into the relatively high speed. This is experienced by the driver as accelerating out of the roundabout, which results in his vehicle leaving the roundabout rapidly. In this way, vehicles traveling behind are not impeded and possible tail-end collisions are avoided. Moreover, the driver is provided with a dynamic driving experience.

According to one aspect of the present invention, the speed adaptation occurs in a smoothed or continuous fashion such that the individual speed adaptation operations merge seamlessly with one another. In this way, a single driving strategy is generally implemented, but this strategy is experienced by the driver as a single continuous variation of the speed through the bend.

According to one aspect of the present invention, the detection of the exit is carried out by means of route guidance. This has the advantage that without the driver's involvement, that is to say in a fully automated fashion, it is detected which exit is to be used. The data is transferred from the navigation system and it is assumed that the driver actually follows the route instruction. This is advantageous in particular in the case of autonomous driving. Alternatively, the driver can also confirm in this case that he is actually following the navigation.

According to a further aspect of the present invention, the detection of the exit is carried out by setting a flashing indicator light. This has the advantage that even if no navigation data is present, the exit is detected without effort. Therefore, no effort is incurred by the driver since he is prevented from setting the flashing indicator light at the exit and the system detects and processes this in an automated fashion.

According to a further aspect of the present invention, after the setting of the flashing indicator light the next exit is detected as the exit to be driven through. This has the advantage that the next exit can be detected fully automatically by means of a conventional sensor system, that is to say a camera or navigation data. The exit is denoted precisely and unambiguously here.

According to a further aspect of the present invention, only the flashing indicator light in the direction of exits is taken into account. This has the advantage that a flashing indicator light which has been set in error is not taken into account, and even in the case of a multi-lane roundabout changing of the lane is not interpreted as a signal to leave the roundabout. Whether right-hand traffic or left-hand traffic is present can also be detected during travel in an automated fashion, for example on the basis of a front looking camera or of navigation data.

According to a further aspect of the present invention, the acceleration point is provided in a chronological and/or spatial fashion. This has the advantage that either a time frame is set or a distance, with which the acceleration point is described. The acceleration point can therefore lie several seconds before the exit is reached or can lie several meters before the exit. Here, the current speed can also be taken into account and corresponding specifications produced.

According to a further aspect of the present invention, the acceleration to the exit speed is implemented by means of a cruise controller. This has the advantage that a conventional cruise controller can be re-used, but it is actuated according to the invention. In this way, the invention can be implemented with little technical expenditure.

According to a further aspect of the present invention, the exit speed is already defined before the vehicle drives onto the roundabout. This has the advantage that the speed of a cruise controller can be maintained and the driver therefore does not have to incur any effort. This permits the cornering guidance to be integrated seamlessly into an existing longitudinal guidance system.

The object is also achieved by means of a system arrangement for dynamically driving through and leaving a roundabout in an automatic longitudinal guidance operation, comprising a detection unit configured to detect an exit of the roundabout which the vehicle will drive through, wherein a computing unit configured to provide an acceleration point which is located before the exit is provided; and a control unit which is configured to accelerate to an exit speed of the vehicle when the acceleration point is reached is provided.

The detection unit can be present in the form of an optical system and/or can process navigation data. In addition, setting of a flashing indicator light can be read out. The computing unit can already be present in conventional vehicles and is actuated according to the invention. The control unit may be part of a cruise controller.

The object is also achieved by a computer program product having control instructions which execute the method and operate the proposed arrangement when they are executed on a computer.

According to the invention it is particularly advantageous that the method can be used to operate the proposed devices and units or the system arrangement. In addition, the proposed devices and apparatuses are suitable for executing the method according to the invention. The device therefore respectively implements the structural features which are suitable for executing the corresponding method. The structural features can, however, also be configured as method steps. The proposed method also provides steps for implementing the function of the structural features.

Further advantages, features and details of the invention can be found in the following description in which aspects of the invention are described in detail with reference to the drawings. In this context, the features which are mentioned in the claims and in the description may be respectively significant to the invention, either individually per se or in any desired combination. Likewise, the abovementioned features and those which are explained below can each be applied independently or in any desired combinations. The terms “on the left”, “on the right”, “above” and “below” used in the description of the exemplary embodiments refer to the drawings in an orientation with the normally readable designation of the figures or normally readable reference symbols. The embodiments which are shown and described are not to be considered as conclusive but rather have an exemplary character for explaining the invention. The detailed description serves to inform a person skilled in the art, and therefore known circuits, structures and methods are not shown or described in detail in the description, in order to facilitate comprehension of the present description.

### BRIEF DESCRIPTION OF THE DRAWINGS

FIG. 1 shows a schematic overview of an application example (case 1) of the method for traveling through and leaving a roundabout in an automatic longitudinal guidance operation according to one aspect of the present invention;

FIG. 2 shows a schematic overview of a further application example (case 2) of the method for driving through and leaving a roundabout in an automatic longitudinal guidance operation according to one aspect of the present invention; and

FIG. 3 shows a schematic flow diagram of the proposed method according to a further aspect of the present invention.

### DETAILED DESCRIPTION OF THE DRAWINGS

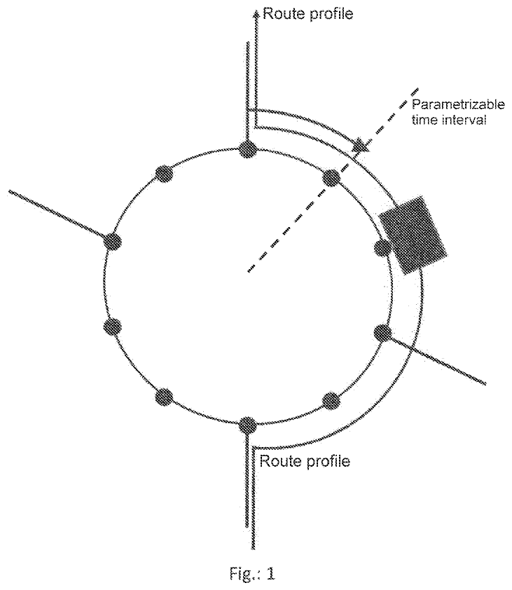

FIG. 1 shows a schematic overview of the detection of a vehicle leaving according to case 1. Here, the vehicle detects the point of leaving on the basis of a set active target guidance system. If a target guidance system is active, it can be assumed on the basis of the prediction that the leaving takes place at the location which the navigation system proposes. In order to generate the necessary perceptible dynamics at the roundabout exit, according to one aspect of the present invention the adjustment to the roundabout is ended in advance by a predetermined time interval and is output to the cruise controller in order to bring about acceleration to the set speed.

The maximum desired or safe lateral acceleration can also be taken into account, the acceleration indicating in accordance with a specific radius of the bend how fast the bend can be driven through. In the case of a sporty driving style, a higher lateral acceleration is tolerated than in the case of a comfortable mode. Furthermore, a geometric method can be applied which analyzes the bend in respect of its inclination, for example on the basis of the curvature or radius of the bend.

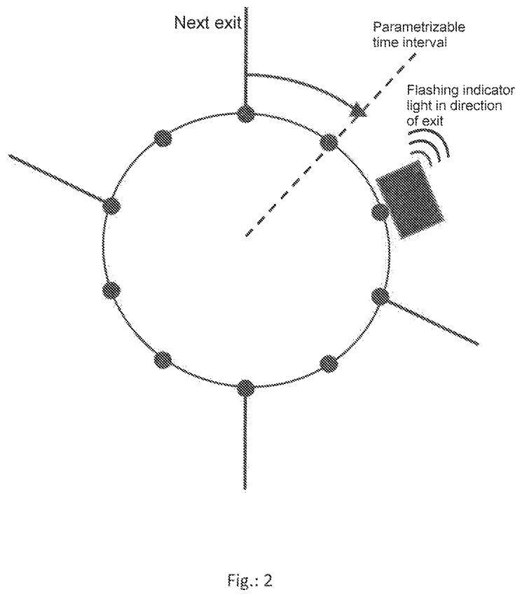

FIG. 2 shows a schematic overview of the detection of leaving according to case 2. Here, the vehicle does not know the point of leaving in advance. If a target guidance system is not active, a prediction as to when the roundabout is exited can be made on the basis of the flashing indicator light in the direction of the exit. According to one aspect of the present invention, the closest possible exit after the setting of the flashing indicator light is assumed for this. A flashing indication in the opposite direction does not bring about detection of leaving. In order, in turn, to generate the necessary perceptible dynamics at the roundabout exit, the adjustment to the roundabout is ended in advance by a specific time interval and is output to the cruise controller for the purpose of acceleration to the set speed.

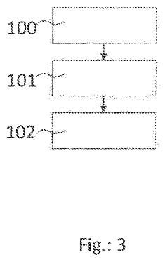

FIG. 3 shows a schematic flow diagram of a method for dynamically driving through and leaving a roundabout in an automatic longitudinal guidance operation, comprising detecting 100 an exit of the roundabout which the vehicle will drive through, wherein an acceleration point which is located before the exit is provided 101; and acceleration 102 to an exiting speed of the vehicle is implemented when the acceleration point is reached.

A person skilled in the art detects here that the steps can comprise further sub-steps and, in particular, that the method steps can each be executed iteratively and/or in a different sequence.

Not shown here is a data memory or a computer-readable medium with a computer program product comprising control instructions which implement the proposed method or operate the proposed system arrangement when they are executed on a computer.

1.-10. (canceled)

11. A method for dynamically driving through and leaving a roundabout in an automatic longitudinal guidance operation, comprising the steps of:
detecting an exit of the roundabout which a vehicle will drive through;
providing an acceleration point which is located before the exit; and
accelerating the vehicle to an exit speed of the vehicle when the acceleration point is reached by the vehicle.

12. The method according to claim 11, wherein the detecting of the exit is performed by route guidance.

13. The method according to claim 11, wherein the detecting of the exit is performed by setting a flashing indicator light.

14. The method according to claim 13, wherein after the setting of the flashing indicator light a next exit is detected as the exit of the roundabout which the vehicle will drive through.

15. The method according to claim 13, wherein only a flashing indicator light in a direction of the exit is taken into account.

16. The method according to claim 11, wherein the acceleration point is provided in a chronological and/or a spatial manner.

17. The method according to claim 11, wherein the accelerating of the vehicle to the exit speed is implemented by a cruise controller.

18. The method according to claim 11, wherein the exit speed is defined before the vehicle drives onto the roundabout.

19. A system for dynamically driving through and leaving a roundabout in an automatic longitudinal guidance operation, comprising:
a detection unit configured to detect an exit of the roundabout which a vehicle will drive through;
a computing unit configured to provide an acceleration point which is located before the exit; and
a control unit which is configured to accelerate the vehicle to an exit speed of the vehicle when the acceleration point is reached by the vehicle.

20. A computer program product comprising control instructions which execute the method according to claim 11 when the control instructions are executed on a computer.
